(19) United States
(12) Patent Application Publication
(10) Pub. No.: US 2014/0287713 A1
(43) Pub. Date: Sep. 25, 2014

(54) COMMUNICATION CONTROL DEVICE, COMMUNICATION CONTROL METHOD, AND COMMUNICATION SYSTEM

(71) Applicant: Fujitsu Limited, Kawasaki-shi (JP)

(72) Inventors: Sadamu KIJIYA, Kawasaki (JP); Yukiko YOKOSAWA, Kawasaki (JP)

(73) Assignee: Fujitsu Limited, Kawasaki-shi (JP)

(21) Appl. No.: 14/179,295

(22) Filed: Feb. 12, 2014

(30) Foreign Application Priority Data
Mar. 25, 2013 (JP) 2013-062349

(51) Int. Cl. H04W 4/22

(52) U.S. Cl. CPC H04W 4/22
USPC 455/404.2; 455/404.1

(57) ABSTRACT

A communication control device includes: a memory; and a processor coupled to the memory and configured to: acquire association information in which identification information of a first communication terminal is associated with identification information of a second communication terminal that is different from the first communication terminal, detect occurrence of a disaster, and execute call control so as to call the first communication terminal and the second communication terminal and enable a call to be established between the first communication terminal and the second communication terminal based on the acquired association information when the processor detects the occurrence of the disaster.

### CROSS-REFERENCE TO RELATED APPLICATION

This application is based upon and claims the benefit of priority of the prior Japanese Patent Application No. 2013-062349, filed on Mar. 25, 2013, the entire contents of which are incorporated herein by reference.

### FIELD

The embodiment discussed herein is related to a communication control device, a communication control method, and a communication system.

### BACKGROUND

Traditionally, a technique for easing an access control to restrict an access for a call based on the number of connected terminals or the states of connections for each of groups upon the occurrence of a disaster is known (refer to, for example, International Publication Pamphlet No. WO2008/126280). In addition, a technique for causing an exchange to record off-hooks of subscriber terminals upon congestion and sequentially notifying unconnected terminals that the exchange may receive dial signals from the terminals is known (refer to, for example, Japanese Laid-open Patent Publication No. 8-317435).

### SUMMARY

According to an aspect of the invention, a communication control device includes: a memory; and a processor coupled to the memory and configured to: acquire association information in which identification information of a first communication terminal is associated with identification information of a second communication terminal that is different from the first communication terminal, detect occurrence of a disaster, and execute call control so as to call the first communication terminal and the second communication terminal and enable a call to be established between the first communication terminal and the second communication terminal based on the acquired association information when the processor detects the occurrence of the disaster.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a communication system according to the embodiment;

FIG. 1B is a diagram illustrating an example of the flows of signals in the communication system illustrated in FIG. 1A;

FIG. 2 is a diagram illustrating a specific example of the communication system;

FIG. 3 is a diagram illustrating an example of the configuration of a communication control device;

FIG. 4 is a diagram illustrating an example of a hardware configuration of a communication control device;

FIG. 5A is a diagram illustrating an example of an MCU installed in the communication system;

FIG. 5B is a diagram illustrating an example of the flows of signals in the MCU illustrated in FIG. 5A;

FIG. 6 is a diagram illustrating an example of connection destination information;

FIG. 7 is a diagram illustrating an example of a connection priority table;

FIG. 8 is a diagram illustrating an example of a correspondence table that indicates correspondence relationships between geographical conditions and priority points;

FIG. 9 is a flowchart of an example of a process that is executed by the communication control device when a disaster is detected;

FIG. 10 is a flowchart of an example of a call and connection process;

FIG. 11 is a flowchart of an example of a voice call and unattended communication process;

FIG. 12 is a flowchart of an example of a voice mail process;

FIG. 13 is a flowchart of an example of a message board process;

FIG. 14 is a sequence diagram illustrating an example of registration operations that are executed in the communication system;

FIG. 15 is a sequence diagram illustrating an example of preparation operations that are executed when the communication system detects a disaster;

FIG. 16 is a sequence diagram illustrating a first example of a connection process that is executed in the communication system;

FIG. 17 is a sequence diagram illustrating a second example of the connection process that is executed in the communication system; and

FIG. 18 is a sequence diagram illustrating a third example of the connection process that is executed in the communication system.

### DESCRIPTION OF EMBODIMENT

Hereinafter, a communication control device, a communication control method, and a communication system according to the embodiment are described in detail with reference to the accompanying drawings.

While inventing the present embodiments, observations were made regarding a related art. Such observations include the following, for example.

The techniques in a communication system of the related art have a problem that the safety of a user may not be efficiently confirmed upon the occurrence of a disaster.

Therefore, in order to solve the problem with the conventional techniques, an object of the embodiment is to provide a communication control device, a communication control method, and a communication system that improve the efficiency of confirming the safety of a user.

Communication System According to Embodiment

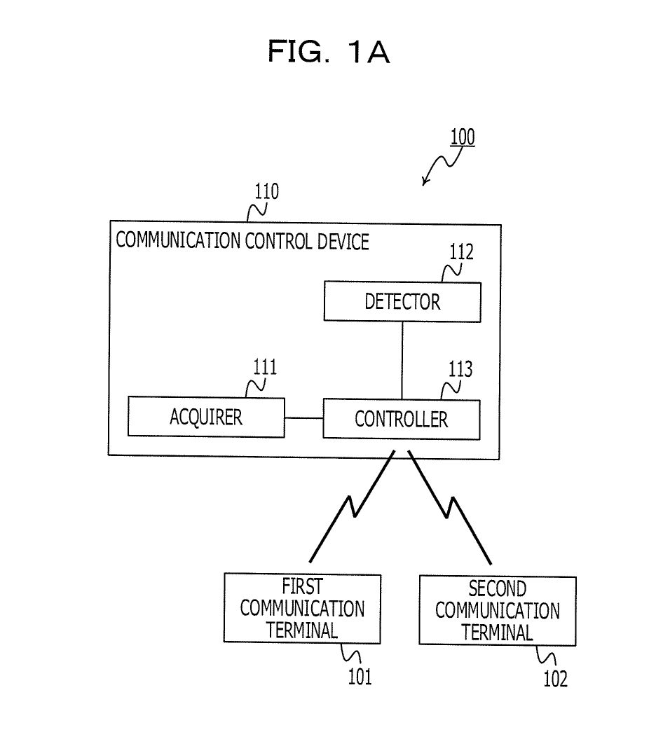

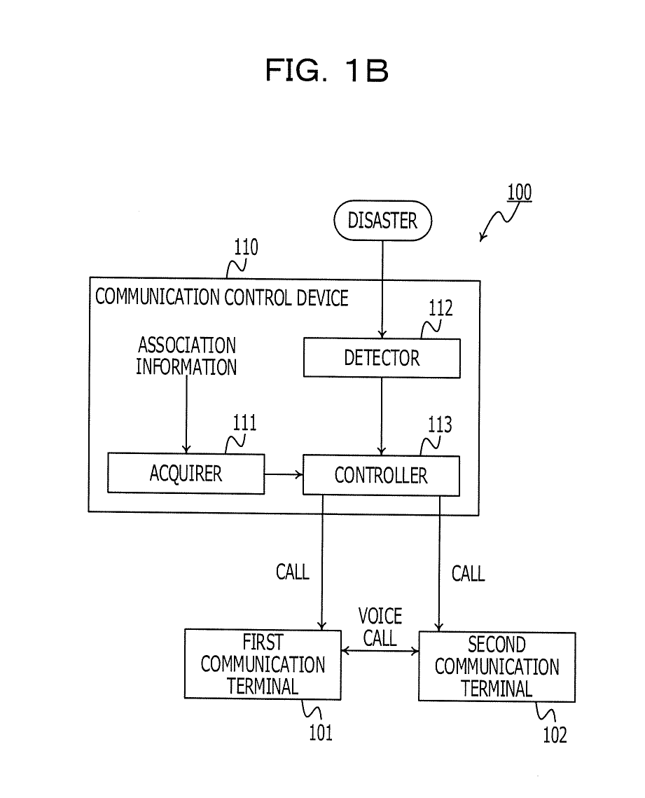

FIG. 1A is a diagram illustrating an example of the communication system according to the embodiment. FIG. 1B is a diagram illustrating an example of the flows of signals in the communication system illustrated in FIG. 1A. As illustrated in FIGS. 1A and 1B, a communication system 100 according to the embodiment includes a communication control device 110, a first communication terminal 101, and a second communication terminal 102.

The first communication terminal 101 and the second communication terminal 102 are mobile phone terminals that may communicate with each other through a call or landline phones that may communicate with each other through a call. For example, the second communication terminal 102 is a communication terminal registered before the occurrence of a disaster as contact information of the first communication terminal 101 for the occurrence of a disaster.

The communication control device 110 controls direct or indirect communication between the first communication terminal 101 and the second communication terminal 102 upon the occurrence of a disaster. The communication control device 110 includes an acquirer 111, a detector 112, and a controller 113.

The acquirer 111 acquires association information. The association information is information in which an identification number (for example, a phone number) of the first communication terminal 101 is associated with an identification number (for example, a phone number) of the second communication terminal 102. The acquirer 111 may acquire the association information from a memory of the communication control device 110 or may acquire the association information by receiving the association information from an external communication device. The acquirer 111 outputs the acquired association information to the controller 113.

The detector 112 detects the occurrence of a disaster. For example, the detector 112 detects the occurrence of a disaster by receiving a signal indicating the occurrence of the disaster from an external communication device. When detecting the occurrence of the disaster, the detector 112 notifies the controller 113 of the occurrence of the disaster.

When receiving the notification indicating the occurrence of the disaster from the detector 112, the controller 113 calls the first communication terminal 101 and the second communication terminal 102 and executes call control so as to enable a call to be established between the first communication terminal 101 and the second communication terminal 102.

In this manner, the communication control device 110 calls the first communication terminal 101 and the second communication terminal 102 (registered as the contact information of the first communication terminal 101 in advance) on its own initiative upon the occurrence of a disaster and enables a call to be established between the first communication terminal 101 and the second communication terminal 102.

For example, a user of the first communication terminal 101 may communicate with a user of the second communication terminal 102 through a call and confirm the safety of the user of the second communication terminal 102 without placing a call operation to the second communication terminal 102. Thus, a call from the first communication terminal 101 upon the occurrence of a disaster may be suppressed. It may be therefore possible to confirm the safety while suppressing an increase in the number of requests for communication upon the occurrence of a disaster and to improve the efficiency of confirming the safety.

Call Control for Plurality of First Communication Terminals

A plurality of the first communication terminals 101 may be provided. In this case, in the association information acquired by the acquirer 111, identification numbers of the first communication terminals 101 may be associated with the identification number of the second communication terminal 102 registered as the contact information of the first communication terminals 101.

In this case, the controller 113 sequentially execute the call control so as to enable a call to be established between each of the first communication terminals 101 and the second communication terminal 102. Thus, calls from the first communication terminals 101 upon the occurrence of a disaster may be suppressed. It may be therefore possible to confirm the safety while suppressing an increase in the number of requests for communication upon the occurrence of a disaster and to improve the efficiency at which users of the first communication terminals 101 confirm the safety of the user of the second communication terminal 102.

The controller 113 may set limits on call times of the first communication terminals 101. In this case, it may be possible to reduce the call times of the first communication terminals 101 and improve the efficiency at which the users of the first communication terminals 101 confirm the safety of the user of the second communication terminal 102.

The controller 113 may execute the call control on the first communication terminals 101 in the order based on a geographical relationship between a location at which a disaster has occurred and the location of at least any of the first and second communication terminals 101 and 102. For example, the controller 113 may execute the call control on the first communication terminals 101 in the order from a first communication terminal 101 that is among the first communication terminals 101 and located closest to a location at which a disaster has occurred to a first communication terminal 101 that is among the first communication terminals 101 and located farthest from the location at which the disaster has occurred. It may be therefore possible to suppress an increase in the number of requests for communication in an area in which congestion easily occurs and to improve the efficiency of confirming the safety.

The controller 113 may execute the call control on the first communication terminals 101 in the order from a first communication terminal 101 that is among the first communication terminals 101 and associated with a second communication terminal 102 located closest to a location at which a disaster has occurred to a first communication terminal 101 that is among the first communication terminals 101 and associated with a second communication terminal 102 located farthest from the location at which the disaster has occurred. It may be therefore possible to suppress an increase in the number of requests for communication in an area in which congestion easily occurs and to improve the efficiency of confirming the safety.

The controller 113 may execute the call control on the first communication terminals 101 in the order based on an access control provided for a service area in which at least any of the first and second communication terminals 101 and 102 is located. The access control indicates, for example, restricting an access for communication in the service area. The access control is, for example, to prevent a terminal from making an access attempt, or responding to paging. For example, the controller 113 may execute the call control on a first communication terminal 101 located in a service area for which an access control is provided before executing the call control on a first communication terminal 101 located in a service area for which an access control is not provided. In this case, it may be possible to suppress an increase in the number of requests for communication in an area for which a call is not easily established due to an access control and to improve the efficiency of confirming the safety.

The controller 113 may execute the call control on a first communication terminal 101 associated with a second communication terminal 102 located in an area for which an access control is provided before executing the call control on a first communication terminal 101 associated with a second communication terminal 102 located in an area for which an access control is not provided. In this case, it may be possible to suppress an increase in the number of requests for communication in an area for which a call is not easily established due to an access control and to improve the efficiency of confirming the safety.

The controller 113 may execute the call control on the first communication terminals 101 in the order based on the state of congestion that has occurred in a service area in which any of the first and second communication terminals 101 and 102 is located. For example, the controller 113 may execute the call control on a first communication terminal 101 located in a service area in which congestion is heavy before executing the call control on a first communication terminal 101 located in a service area in which congestion is not heavy. In this case, it may be possible to suppress an increase in the number of requests for communication in an area for which a call is not easily established and to improve the efficiency of confirming the safety.

The controller 113 may execute the call control on a first communication terminal 101 associated with a second communication terminal 102 located in an area in which congestion is heavy before executing the call control on a first communication terminal 101 associated with a second communication terminal 102 located in an area in which congestion is not heavy. In this case, it may be possible to suppress an increase in the number of requests for communication in an area for which a call is not easily established and to improve the efficiency of confirming the safety.

Voice Message as Alternative

The controller 113 may execute control using a voice message as an alternative of a voice call. For example, if the occurrence of a disaster is detected, the controller 113 calls the first communication terminal 101 and receives a voice message from the first communication terminal 101. Then, the controller 113 calls the second communication terminal 102 and transfers the voice message received from the first communication terminal 101 to the second communication terminal 102.

For example, the controller 113 transfers the voice message received from the first communication terminal 101 to the second communication terminal 102 through another device (for example, a message system 1700 described later). The controller 113 may transfer the voice message received from the first communication terminal 101 directly to the second communication terminal 102.

If the occurrence of a disaster is detected, the controller 113 may call the second communication terminal 102 and receive a voice message from the second communication terminal 102. Then, the controller 113 may call the first communication terminal 101 and transfer the voice massage received from the second communication terminal 102 to the first communication terminal 101.

For example, the controller 113 transfers the voice massage received from the second communication terminal 102 to the first communication terminal 101 through another device (for example, the message system 1700 described later). The controller 113 may transfer the voice message received from the second communication terminal 102 directly to the first communication terminal 101.

Thus, if at least any of the first and second communication terminals 101 and 102 may not place and receive a call or does not place and receive a call, the safety may be confirmed using a voice message.

Text Message as Alternative

The controller 113 may execute control using a text message as an alternative of a voice call. For example, if the occurrence of a disaster is detected, the controller 113 calls the first communication terminal 101 and receives a text message from the first communication terminal 101. Then, the controller 113 calls the second communication terminal 102 and transfers the text message received from the first communication terminal 101 to the second communication terminal 102.

For example, the controller 113 transfers the text message received from the first communication terminal 101 to the second communication terminal 102 through another device (for example, the message system 1700 described later). The controller 113 may transfer the text message received from the first communication terminal 101 directly to the second communication terminal 102.

If the occurrence of a disaster is detected, the controller 113 calls the second communication terminal 102 and receives a text message from the second communication terminal 102. Then, the controller 113 calls the first communication terminal 101 and transfers the text message received from the second communication terminal 102 to the first communication terminal 101.

For example, the controller 113 transfers the text message received from the second communication terminal 102 to the first communication terminal 101 through another device (for example, the message system 1700 described later). The controller 113 may transfer the text message received from the second communication terminal 102 directly to the first communication terminal 101.

Thus, if at least any of the first and second communication terminals 101 and 102 may not place and receive a call or does not place and receive a call, the safety may be confirmed using a text message.

Selection of Contact Method

In the association information acquired by the acquirer 111, the identification information of the first communication terminal 101 is associated with a contact method that the user of the first communication terminal 101 wants to use. The contact method is any of a voice call, a voice message, and a text message, for example. The controller 113 enables, based on the association information, the first communication terminal 101 and the second communication terminal 102 to communicate with each other using the contact method associated with the first communication terminal 101.

If the first communication terminal 101 and the second communication terminal 102 respond to voice calls received by the first and second communication terminals 101 and 102, the controller 113 may enable a call to be established between the first communication terminal 101 and the second communication terminal 102. If at least any of the first communication terminal 101 and the second communication terminal 102 does not respond to a received voice call, the controller 113 may enable the first communication terminal 101 and the second communication terminal 102 to communicate with each other using a voice message or a text message.

Transfer of Recorded Data

If a plurality of the second communication terminals 102 are associated with the first communication terminal 101 in the association information acquired by the acquirer 111, the controller 113 may execute the following control. That is, if the occurrence of a disaster is detected by the detector 112, the controller 113 calls the first communication terminal 101 and the plurality of second communication terminals 102 and enables calls to be simultaneously established between the first communication terminal 101 and the plurality of second communication terminals 102 by a multipoint connection.

If at least any of the called first communication terminal 101 and the called second communication terminals 102 does not respond to a call, and a plurality of communication terminals among the first and second communication terminal 101 and 102 respond to calls, the controller 113 may execute the following control. That is, the controller 113 enables a call to be established between the plurality of communication terminals that have responded to the calls. After the call between the plurality of communication terminals that have responded is terminated, the controller 113 calls the other communication terminals that have not responded and transfers recorded data of the call to the other communication terminals that have not responded.

Thus, the safety may be quickly confirmed by the call between the plurality of communication terminals that are among the first communication terminal 101 and the plurality of second communication terminals 102 and have responded to the calls. In addition, the safety may be confirmed by transferring, to the communication terminals that are among the first communication terminal 101 and the plurality of second communication terminals 102 and have not responded to the calls, the recorded data of the call between the plurality of communication terminals that have responded.

Specific Example of Communication System

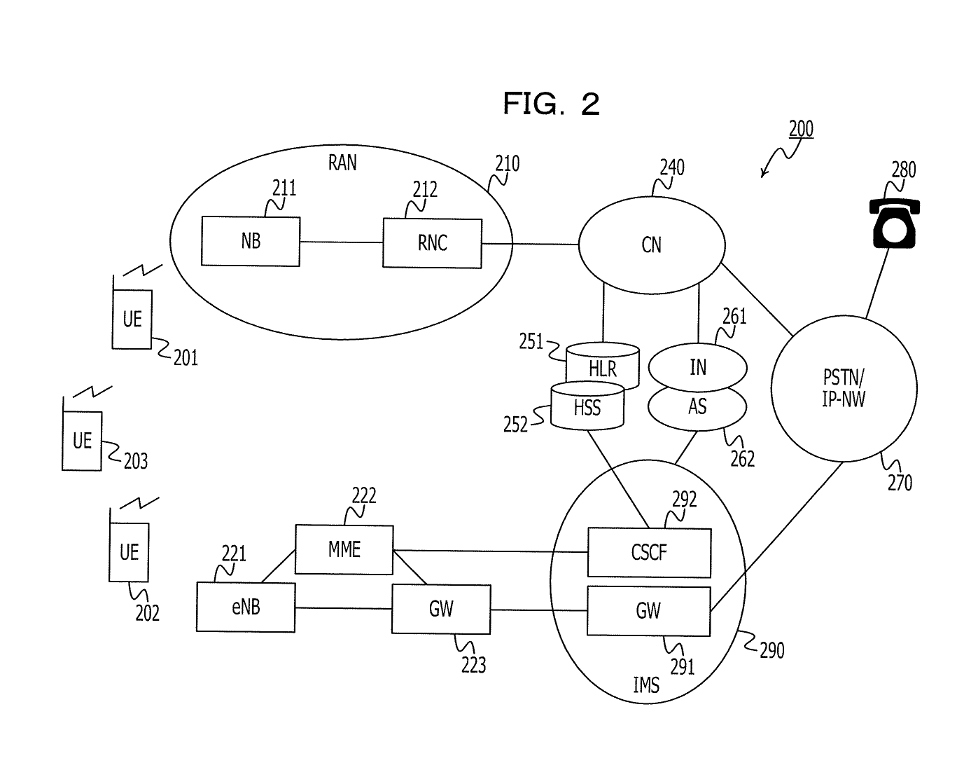

FIG. 2 is a diagram illustrating a specific example of the communication system. The communication system 100 illustrated in FIGS. 1A and 1B may be achieved by a communication system 200 illustrated in FIG. 2. The communication system 200 includes a landline phone 280, 3G, and Long Term Evolution (LTE).

The communication system 200 includes user equipment (UE) 201 to 203, a radio access network (RAN) 210, an evolved node B (eNB) 221, a mobility management entity (MME) 222, and a gateway (GW) 223. The communication system 200 also includes a core network (CN) 240, a home location register (HLR) 251, a home subscriber server (HSS) 252, an intelligent network (IN) 261, an application server (AS) 262, a PSTN/IP-NW 270, the landline phone 280, and an Internet Protocol multimedia subsystem (IMS) 290.

The UE 201 to 203 is radio communication terminals that communicate with a node B (NB) 211 and the eNB 221. The first and second communication terminals 101 and 102 illustrated in FIGS. 1A and 1B are applicable to the user equipment 201 to 203.

The RAN 210 includes the NB 211 and a radio network controller (RNC) 212. The NB 211 is a base station that executes radio communication with the user equipment 201 to 203. The RNC 212 controls the radio communication to be executed by the NB 211 and relays communication between the NB 211 and the core network 240.

The eNB 221 is a base station that execute radio communication with the user equipment 201 to 203. The eNB 221 is connected to the MME 222 and the GW 223 through an S1 interface.

The core network 240 is connected to the RAN 210, the HLR 251, and the HSS 252. In addition, the core network 240 is connected to the IN 261, the AS 262, and the PSTN/IP-NW 270. The IN 261 and the AS 262 may be achieved by a single communication device or may be achieved by different communication devices. The communication control device 110 illustrated in FIGS. 1A and 1B may be achieved by the AS 262.

Location registration information and contact information are stored in the HLR 251 and the HSS 252. The HLR 251 and the HSS 252 may be achieved by a single communication device or may be achieved by different communication devices.

The PSTN/IP-NW 270 includes public switched telephone networks (PSTN) and an Internet Protocol (IP) network. The PSTN/IP-NW 270 is connected to the landline phone 280. The first and second communication terminals 101 and 102 illustrated in FIGS. 1A and 1B are applicable to the landline phones 280, for example.

The IMS 290 includes a gateway (GW) 291 and a call session control function (CSCF) 292. The GW 291 is installed between the GW 223 and the PSTN/IP-NW 270. The CSCF 292 is connected to the MME 222, the HLR 251, and the HSS 252.

Configuration of Communication Control Device

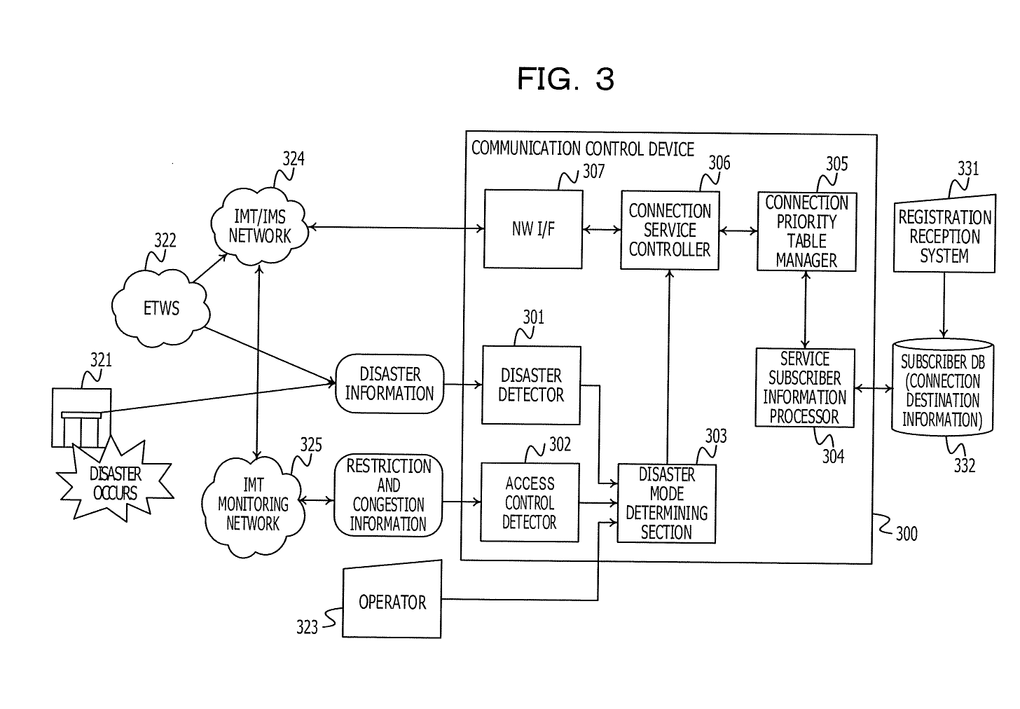

FIG. 3 is a diagram illustrating an example of the configuration of the communication control device. The communication control device 110 illustrated in FIGS. 1A and 1B is applicable to a communication control device 300 illustrated in FIG. 3, for example. The communication control device 300 includes a disaster detector 301, an access control access control detector 302, a disaster mode determining section 303, a service subscriber information processor 304, a connection priority table manager 305, a connection service controller 306, and a network interface (NW_I/F) 307.

The disaster detector 301 detects the occurrence of a disaster by receiving disaster information from a supervisory ministry or agency 321. The disaster information includes information indicating the occurrence of the disaster, information indicating an alarm, and the like. The supervisory ministry or agency 321 may be Japan Meteorological Agency (in the case of a natural disaster), Ministry of Economy, Trade, and Industry (in the case of an accident of a nuclear power plant), or the like. The disaster detector 301 may receive the disaster information through the Earthquake and Tsunami Warning System (ETWS) 322 standardized by the 3GPP.

The disaster detector 301 determines, based on the received disaster information, the scale (for example, any of disaster scales “a” to “c”) of the disaster and a region in which the disaster has occurred. Then, the disaster detector 301 outputs the results of the determination to the disaster mode determining section 303.

The disaster detector 301 receives the disaster information from the supervisory ministry or agency 321 and thereby may detect the occurrence of a secondary disaster (additional disaster) after the start of an automatic connection service by the communication control device 300. The secondary disaster may be a tsunami, a fire, or the like that occurs several tens of minutes to several hours after the primary disaster such as an earthquake. When detecting the occurrence of the secondary disaster, the disaster detector 301 notifies the disaster mode determining section 303 of the occurrence of the secondary disaster.

The access control detector 302 collects restriction and congestion information that includes information indicating an implementation status of an access control to restrict an access for communication, information indicating the state of congestion, information (location area (LA) information) of a location at which the congestion occurs, and the like. For example, the access control detector 302 collects the restriction and congestion information through an IMT monitoring network 325 from an IMT/IMS network 324 that is a communication network to which the service is to be provided. The access control detector 302 outputs the collected restriction and congestion information to the disaster mode determining section 303.

The disaster mode determining section 303 instructs the connection service controller 306 to provide or cancel the automatic connection service based on the region that has been notified by the disaster detector 301 and in which the disaster has occurred, the disaster scale notified by the disaster detector 301, and the restriction and congestion information output from the access control detector 302. The disaster mode determining section 303 may instruct the connection service controller 306 to provide or cancel the automatic connection service based on an instruction from an operator 323 of a telecommunications carrier. In this case, the telecommunications carrier may determine whether the automatic connection service is provided or cancelled.

A registration reception system 331 is a system that registers and updates subscribers who subscribe to the automatic connection service that is provided by the communication control device 300. The registration reception system 331 may be achieved by a system that may be connected to a communication terminal of a shop of the telecommunications carrier and communication terminals (for example, the user equipment 201 to 203) through a network.

A subscriber DB 332 is a database of the subscribers who subscribe to the automatic connection service that is provided by the communication control device 300. The subscriber DB 332 may be achieved by the HLR 251 illustrated in FIG. 2 or the HSS 252 illustrated in FIG. 2. The subscriber DB 332 is updated based on a result received by the registration reception system 331.

The service subscriber information processor 304 acquires information to be used for the automatic connection service from the subscriber DB 332 and outputs the acquired information to the connection priority table manager 305. The connection priority table manager 305 generates and updates a connection priority table based on the information output from the service subscriber information processor 304 under control of the connection service controller 306.

The connection service controller 306 executes the automatic connection service that is provided by the communication control device 300. For example, the connection service controller 306 executes a process of connecting the communication control device 300 to a communication network such as the IMT/IMS network 324 through the NW_I/F 307 based on an instruction from the disaster mode determining section 303 and information of the connection priority table manager 305. For example, the connection service controller 306 manages a limit timer for a call to be placed by the automatic connection service.

The acquirer 111 illustrated in FIGS. 1A and 1B may be achieved by the service subscriber information processor 304. The detector 112 illustrated in FIGS. 1A and 1B may be achieved by the disaster detector 301. The controller 113 illustrated in FIGS. 1A and 1B may be achieved by the connection service controller 306.

Hardware Configuration of Communication Control Device

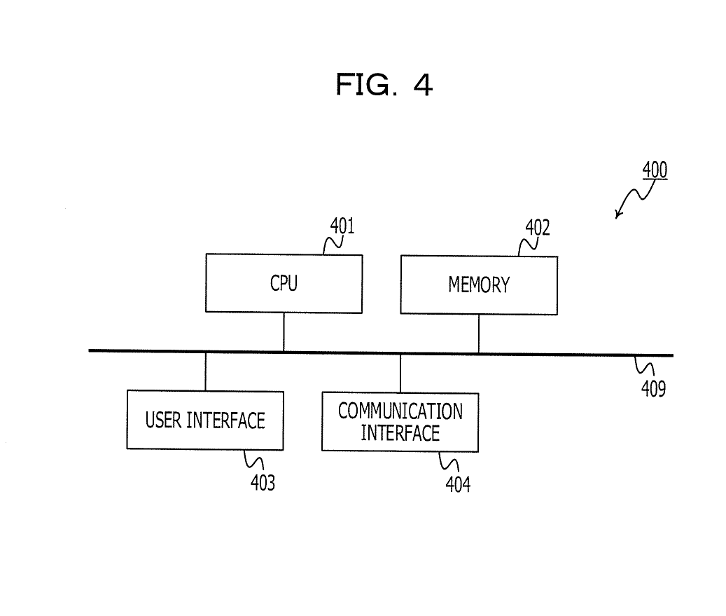

FIG. 4 is a diagram illustrating an example of a hardware configuration of the communication control device. The communication control device 300 illustrated in FIG. 3 may be achieved by an information processing device 400 illustrated in FIG. 4. The information processing device 400 includes a central processing unit (CPU) 401, a memory 402, a user interface 403, and a communication interface 404. The CPU 401, the memory 402, the user interface 403, and the communication interface 404 are connected to each other by a bus 409.

The CPU 401 controls the overall the information processing device 400. The memory 402 includes a main memory and an auxiliary memory, for example. The main memory is, for example, a random access memory (RAM). The main memory is used as a work area of the CPU 401. The auxiliary memory is, for example, a magnetic disk, an optical disc, a non-volatile memory such as a flash memory, or the like. The auxiliary memory stores various programs to be used to operate the information processing device 400. The programs stored in the auxiliary memory are loaded into the main memory and executed by the CPU 401.

The user interface 403 includes an input device and an output device. The input device receives an entry performed by a user. The output device outputs information to the user. The input device may be achieved by keys (for example, a keyboard), a remote controller, or the like. The output device may be achieved by a display, a speaker, or the like. The input device and the output device may be achieved by a touch panel or the like. The user interface 403 is controlled by the CPU 401.

The communication interface 404 communicates with an external (for example, the IMT/IMS network 324) located outside the information processing device 400. The communication interface 404 is controlled by the CPU 401.

The disaster detector 301, the access control detector 302, the service subscriber information processor 304, and the NW_I/F 307 that are illustrated in FIG. 3 may be achieved by the communication interface 404. An input part that receives information from the operator 323 illustrated in FIG. 3 may be achieved by the communication interface 404. The connection priority table manager 305 and the connection service controller 306 that are illustrated in FIG. 3 may be achieved by the CPU 401 and the memory 402.

MCU Installed in Communication System

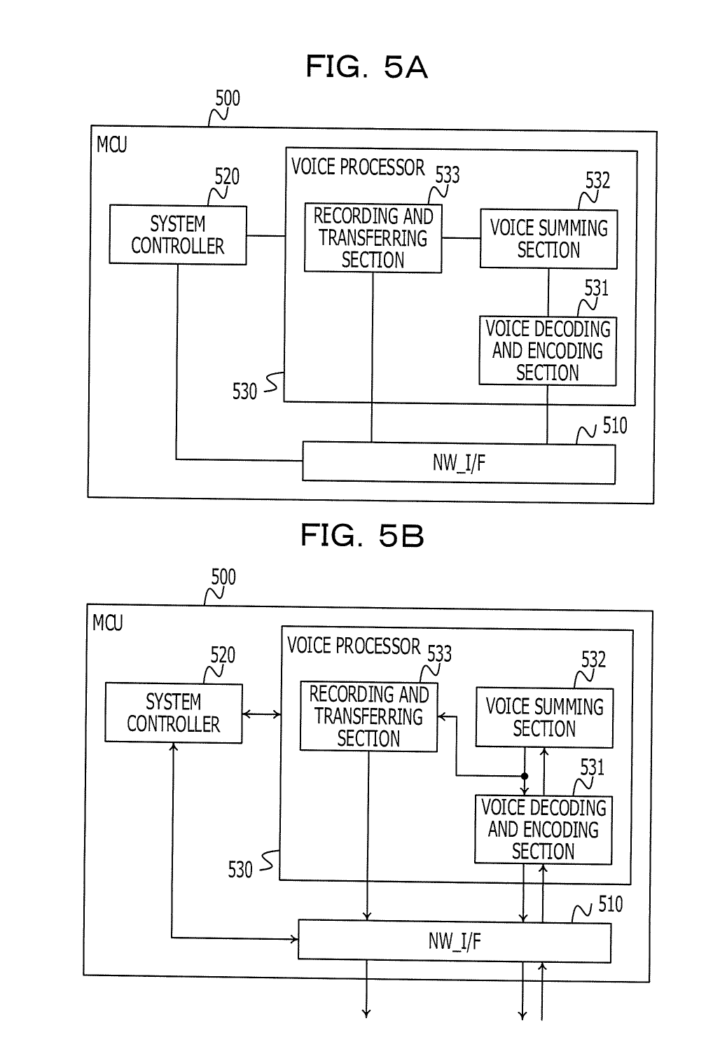

FIG. 5A is a diagram illustrating an example of a multipoint control unit (MCU) installed in the communication system. FIG. 5B is a diagram illustrating an example of the flows of signals in the MCU illustrated in FIG. 5A. The communication system 200 illustrated in FIG. 2 may include an MCU 500 illustrated in FIGS. 5A and 5B. The MCU 500 may be installed in the IN 261. The MCU 500 includes a network interface (NW_I/F) 510, a system controller 520, and a voice processor 530.

The NW_I/F 510 communicates with an external located outside the MCU 500 through a cable, for example. The NW_I/F 510 is controlled by the system controller 520. The system controller 520 controls the NW_I/F 510 and the voice processor 530.

The voice processor 530 includes a voice decoding and encoding section 531, a voice summing section 532, and a recording and transferring section 533. The voice decoding and encoding section 531 decodes voice data received through the NW_I/F 510 from a plurality of communication terminals that communicate with each other through a call. Then, the voice decoding and encoding section 531 outputs the decoded voice data to the voice summing section 532. The voice decoding and encoding section 531 encodes synthesized voice data output from the voice summing section 532. Then, the voice decoding and encoding section 531 transmits the encoded synthesized voice data through the voice processor 530 to the plurality of communication terminals that communicate with each other through a call.

The voice summing section 532 sums the voice data output from the voice decoding and encoding section 531. Then, the voice summing section 532 outputs synthesized voice data obtained by the summing to the voice decoding and encoding section 531 and the recording and transferring section 533.

The recording and transferring section 533 records the synthesized voice data output from the voice summing section 532. Then, the recording and transferring section 533 transfers the recorded data through the NW_I/F 510 to another communication device under control of the system controller 520.

The MCU 500 may be achieved by the information processing device 400 illustrated in FIG. 4. The NW_I/F 510 may be achieved by the communication interface 404 illustrated in FIG. 4. The system controller 520 and the voice processor 530 may be achieved by the CPU 401.

Connection Destination Information

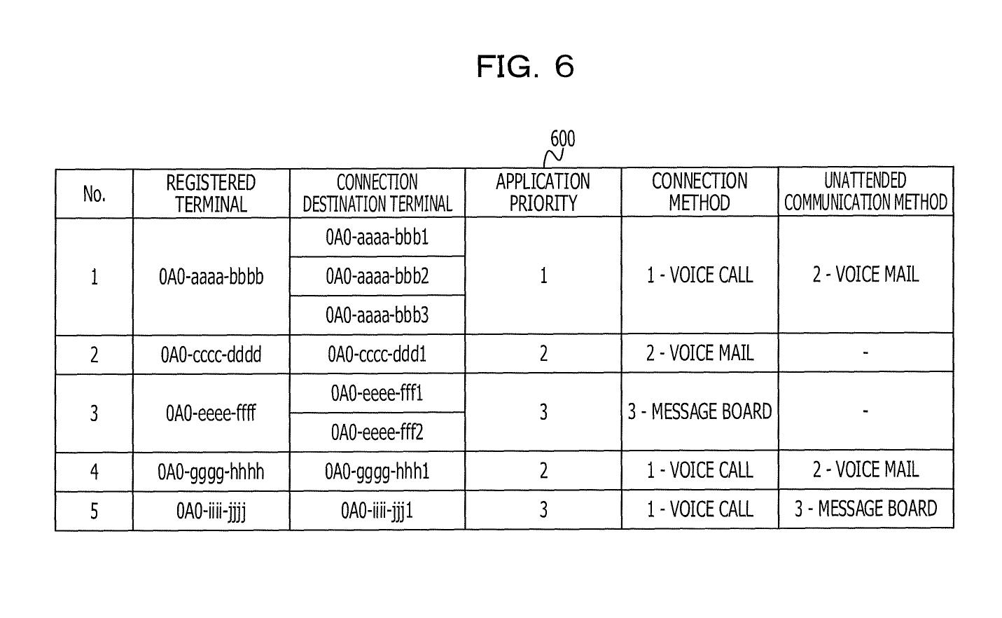

FIG. 6 is a diagram illustrating an example of connection destination information. Connection destination information 600 illustrated in FIG. 6 is generated based on results received by the registration reception system 331 or the like before a disaster occurs. The connection destination information 600 is stored in the subscriber DB 332. In the connection destination information 600, a “number” (No.), a “registered terminal”, a “connection destination terminal”, an “application priority”, a “connection method”, and an “unattended communication method” are associated with each other for each of registrants who subscribe to the automatic connection service that is provided by the communication control device 300.

The “numbers” (Nos.) are sequential numbers of the registrants. The “registered terminals” are identification information (for example, phone numbers) of communication terminals of the registrants who subscribe to the automatic connection service. The “connection destination terminals” are identification information (for example, phone numbers) of communication terminals of families or the like of which the safety is to be confirmed by the registrants. A plurality of “connection destination terminals” may be associated with a single registrant.

The “application priorities” are priorities at which the registered terminals are automatically connected by the automatic connection service. The “application priorities” are determined based on price plans to which the registrants subscribe or the like.

The “connection methods” are connection methods that are used in the automatic connection service in order to confirm the safety upon the occurrence of a disaster. In the example illustrated in FIG. 6, the “connection methods” are “1-voice call”, “2-voice mail” and “3-message board”. The “unattended communication methods” are connection methods that are used in order to confirm the safety when the registrants do not respond to the communication control device 300 upon the occurrence of a disaster. In the example illustrated in FIG. 6, the “unattended communication methods” are “2-voice mail” and “3-message board”.

“1-voice call” is a connection method that is to call a registered terminal and a connection destination terminal and enable a call to be established between the registered terminal and the connection destination terminal. “2-voice mail” is a connection method that is to collect voice messages from a registered terminal and a connection destination terminal and enable the registered terminal and the connection destination terminal to each access the voice message of the other terminal. “3-message board” is a connection method that is to collect text messages from a registered terminal and a connection destination terminal and enable the registered terminal and the connection destination terminal to each access the text message of the other terminal.

Connection Priority Table

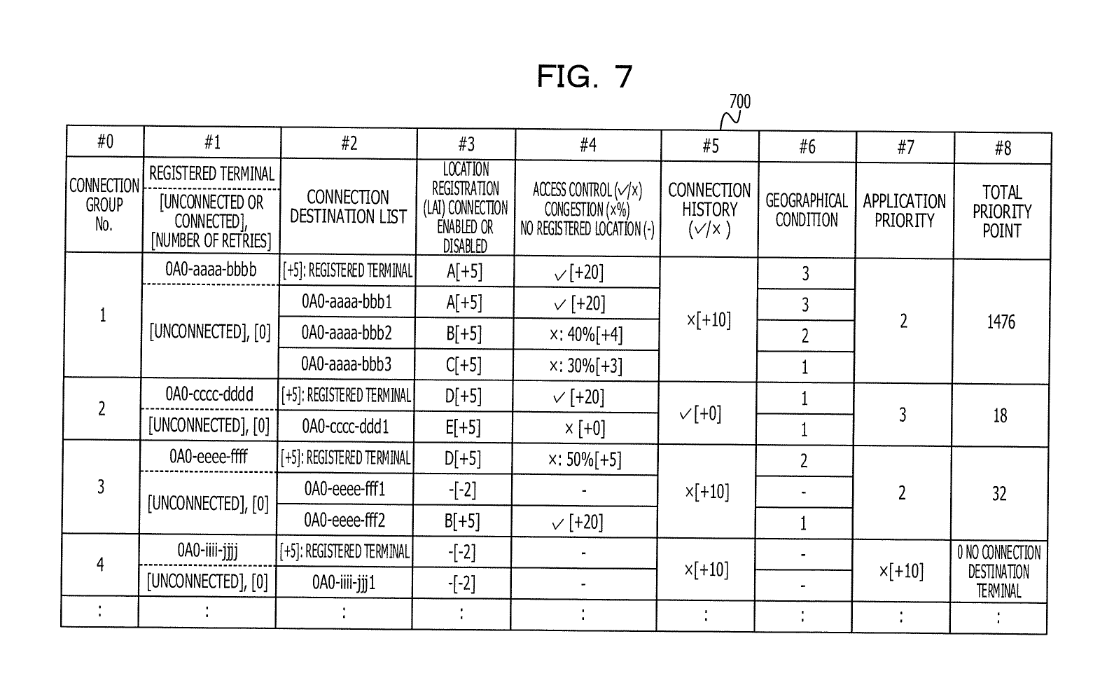

FIG. 7 is a diagram illustrating an example of the connection priority table. The connection priority table manager 305 illustrated in FIG. 3 generates and manages a connection priority table 700 illustrated in FIG. 7 based on the connection destination information 600 illustrated in FIG. 6, for example. In the connection priority table 700, elements #0 to #8 are associated with each other for each of the “registered terminals” indicated by the connection destination information 600. The element #0 includes “connection group numbers” indicating sequential numbers assigned to the registered terminals.

The element #1 includes “registered terminals” indicating the identification numbers (for example, phone numbers) of the registered terminals, “unconnected or connected”, and “numbers of retries”. The “unconnected or connected” indicates whether or not a call and connection process is already executed by the communication control device 300 in the automatic connection service. The “numbers of retries” each indicate the number of times when the call and connection process is executed. For example, if “number of retries” of a registered terminal exceeds a given number, the communication control device 300 may not execute the call and connection process on the registered terminal.

The element #2 is a connection destination list that indicates the registered terminals and identification numbers (for example, phone numbers) of connection destination terminals. A priority point “+5” is added to each of the registered terminals in the element #2.

The element #3 includes, for each terminal, “location registration (LAI) connection enabled or disabled” indicating a location area identity (LAI) that is the identifier of a location registration area of the registered terminal or the identifier of a location registration area of a connection destination terminal. “Location registration (LAI) connection enabled or disabled” indicates “−” for a communication terminal that is not located in a service area and of which the location is not registered. If “location registration (LAI) connection enabled or disabled” indicates “−”, a priority point “−2” is added. If “location registration (LAI) connection enabled or disabled” does not indicate “−”, a priority point “+5” is added.

The element #4 indicates “access control” and/or “congestion” or “no registered location” for each terminal. The “access control” indicates whether or not an access control to restrict an access for communication is provided for an area that includes a registered location of an interested communication terminal. If “access control” indicates “✓”, the access control is provided for an area that includes a registered location of an interested communication terminal. If “access control” indicates “X”, the access control is not provided for an area that includes the registered location of the interested communication terminal. If “access control” indicates “✓”, a priority point “+20” is added. If “access control” indicates “X”, a priority point is not provided by indicating “+0”.

The “congestion” indicates a congestion rate (%) of an area that includes a registered location of an interested communication terminal. A priority point “+1” is added for a congestion rate of 10%. For a communication terminal for which the element #3 indicates “−” and of which the location is not registered, the element #4 indicates “−”.

The element #5 includes “connection history records” that each indicate whether or not there is a history record of connections between an interested registered terminal and all connection destination terminals within a given time period before the occurrence of a disaster. If “connection history record” indicates“✓”, there are history records of connections between the interested registered terminal and all the connection destination terminals. If “connection history record” indicates “X”, there is no history record of a connection between the interested registered terminal and at least any of all the connection destination terminals. If “connection history record” indicates “✓”, a priority point is not added by indicating “+0”. If “connection history record” indicates “X”, a priority point “+10” is added.

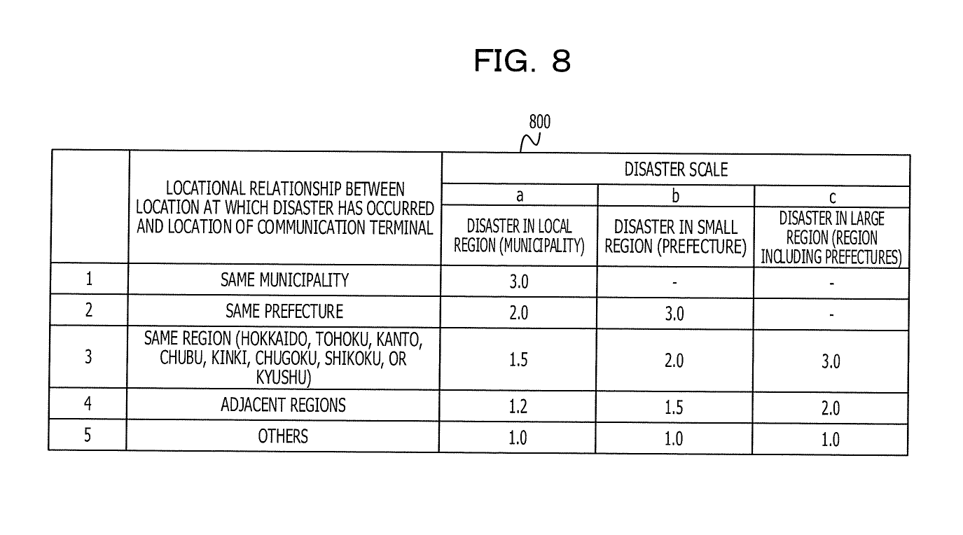

The element #6 includes “geographical conditions” that each indicate a condition based on the scale of a disaster, a distance between an interested communication terminal and a ruined area, and the like. The “geographical conditions” indicate priority points determined based on a correspondence table 800 illustrated in FIG. 8, for example.

The element #7 indicates “application priorities” indicated by the connection destination information 600.

The element #8 indicates “total priority points” that each determine the order that the call and connection process is executed on an interested registered terminal. The “total priority point” is calculated for each of the registered terminals and may be calculated by dividing, by an application priority of the element #7, a value obtained by multiplying the total of priority points of the elements #2 to #5 by a product of priority points of the element #6.

For example, for the registered terminal of which the connection group number is 1, “total priority point” is 1476 (=(5+20+47+10)×(3×3×2×1)/1). A method for calculating a “total priority point” that determines the order that the call and connection process is executed on an interested registered terminal is not limited to the aforementioned method. Other various calculation methods may be used as the method for calculating a “total priority point”.

Correspondence Relationship Between Geographical Condition and Priority Point

FIG. 8 is a diagram illustrating an example of a correspondence table that indicates correspondence relationships between geographical conditions and priority points. The connection priority table manager 305 determines a priority point based on a geographical point based on the correspondence table 800 illustrated in FIG. 8. In the correspondence table 800, priority points are associated with combinations of geographical conditions “1” to “5” and disaster scale (“a” to “c”).

The geographical conditions each indicate a locational relationship between a location at which a disaster has occurred and the location of a communication terminal. The geographical condition “1” indicates the case where a location at which a disaster has occurred and the location of a communication terminal are in the same municipality. The geographical condition “2” indicates the case where a location at which a disaster has occurred and the location of a communication terminal are in the same prefecture. The geographical condition “3” indicates the case where a location at which a disaster has occurred and the location of a communication terminal are in the same region (among Hokkaido, Tohoku, Kanto, Chubu, Kinki, Chugoku, Shikoku, and Kyushu). The geographical condition “4” indicates the case where a location at which a disaster has occurred and the location of a communication terminal are in adjacent regions among the aforementioned regions. The geographical condition “5” indicates a case other than the geographical conditions “1” to “4”.

A geographical condition may be determined based on a region that is indicated by the disaster information acquired by the disaster detector 301 and in which the disaster has occurred and a location registration area, indicated by an LAI illustrated in FIG. 7, of a communication terminal. A disaster scale may be determined based on a disaster scale indicated by the disaster information acquired by the disaster detector 301.

The disaster scale “a” indicates the scale of a disaster that has occurred within a local region such as a municipality. The disaster scale “b” indicates the scale of a disaster that has occurred within a small region such as a prefecture. The disaster scale “c” indicates the scale of a disaster that has occurred within a large region such as a region (among Hokkaido, Tohoku, Kanto, Chubu, Kinki, Chugoku, Shikoku, and Kyushu).

Process to be Executed by Communication Control Device Upon Detection of Disaster

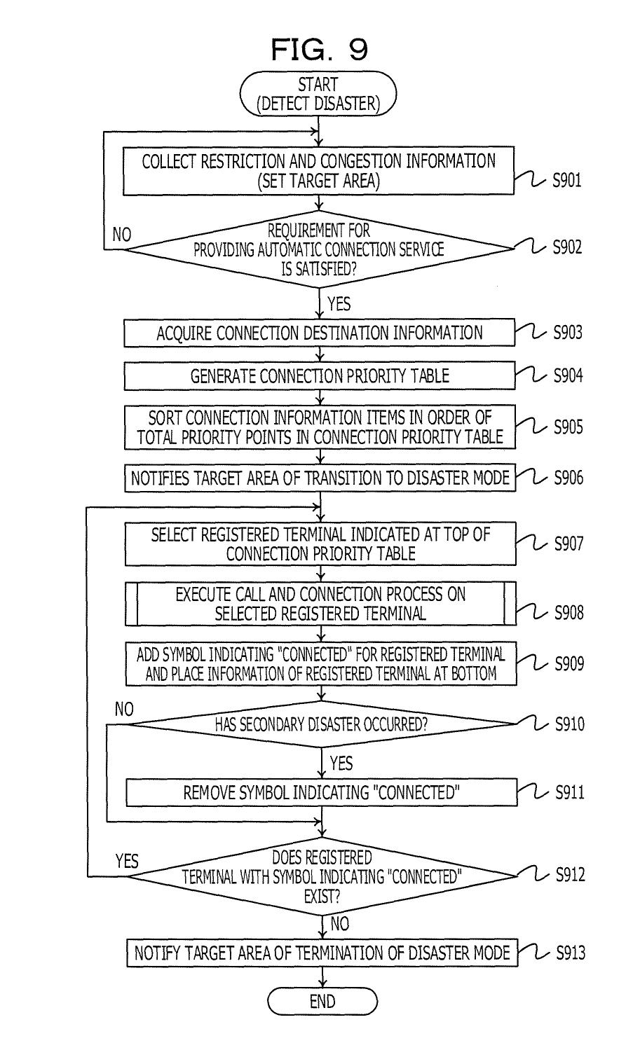

FIG. 9 is a flowchart of an example of a process that is executed by the communication control device 300 when a disaster is detected. When detecting the occurrence of a disaster, the communication control device 300 collects the restriction and congestion information of the network (in step S901). In addition, the communication control device 300 sets, based on the collected restriction and congestion information, a target area for which the automatic connection service is to be provided. In this case, the communication control device 300 may execute a process of suppressing the activation of a service having a low priority.

Next, the communication control device 300 determines, based on the restriction and congestion information collected in step S901, whether or not a requirement for providing the automatic connection service is satisfied (in step S902). The requirement for providing the automatic connection service is that an access control is provided or congestion occurs. If the scale of the disaster that has occurred is large or the operator 323 instructs the communication control device 300 to provide the automatic connection service, the communication control device 300 may determines that the requirement for providing the automatic connection service is satisfied regardless of whether or not an access control is provided or congestion occurs.

If the requirement for providing the automatic connection service is not satisfied (No in step S902), the communication control device 300 causes the process to return to step S901. If the requirement for providing the automatic connection service is satisfied (Yes in step S902), the communication control device 300 acquires connection destination information (for example, the connection destination information 600 illustrated in FIG. 6) from the subscriber DB 332 (in S903).

The communication control device 300 generates a connection priority table (for example, the connection priority table 700 illustrated in FIG. 7) based on the connection destination information acquired in step S903 (in step S904). Then, the communication control device 300 sorts connection information items (registered terminals) indicated by the connection priority table generated in step S904 in the order of total priority points (in step S905). The connection information items are sorted in step S905 in units of connection group numbers of the element #0 illustrated in FIG. 7, for example.

The communication control device 300 notifies the target area set in step S901 of the transition to a disaster mode (in step S906). In this case, the communication control device 300 may notifies each of the registered terminals of a waiting time to the time when the call and connection process is executed. For example, the communication control device 300 notifies each of the registered terminals of a message indicating that “the automatic connection service has started and the registered terminal will be connected within a time of X minutes, so please wait”. The registered terminals each display the message notified by the communication control device 300.

The communication control device 300 may notifies each of the registered terminals of the number of registered terminals located in service areas, a degree of congestion, and the like. For example, the communication control device 300 counts the number of connection destination terminals indicated by the connection priority table for each of location registration areas. In this case, the communication control device 300 may count 1 when a plurality of connection destination terminals belong to the same group. Then, the communication control device 300 causes a counted number and a communication time limit (of, for example, 1 minute, 2 minutes, or the like) to be included in a start message to be provided to an area for which the automatic connection service is to be provided, and thus the communication control device 300 may notifies a user of a criterion for the maximum waiting time in the target area in which a communication terminal is called.

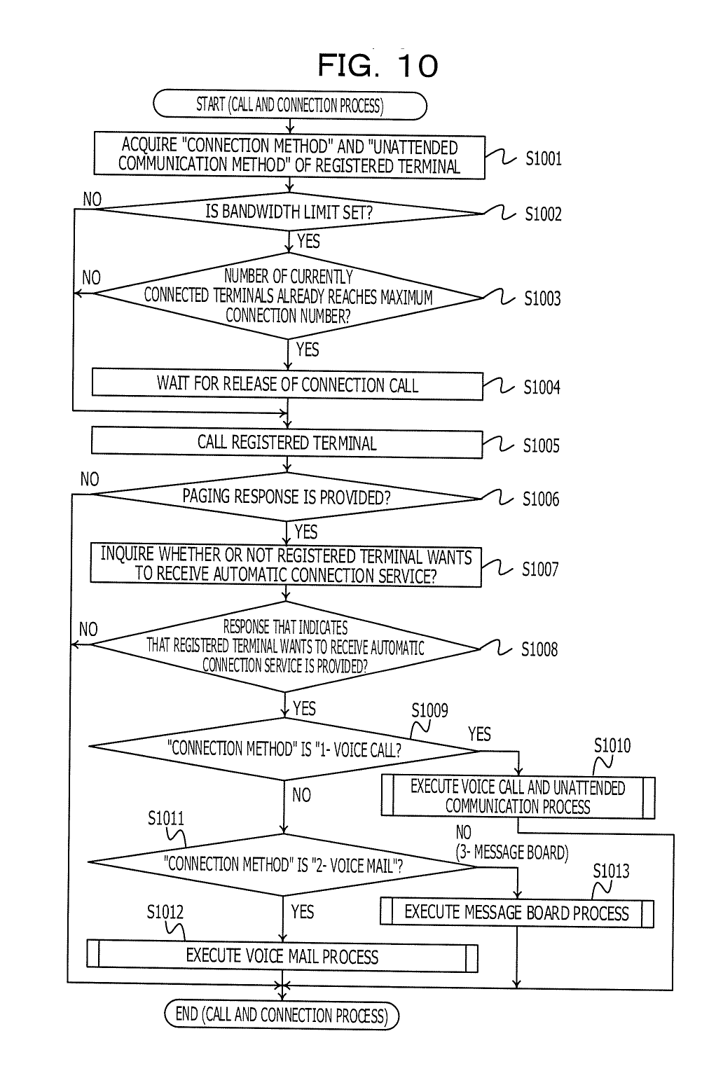

The communication control device 300 selects a registered terminal of which information is indicated at the top in the connection priority table (in step S907). The communication control device 300 executes the call and connection process on the registered terminal selected in step S907 (in step S908). The call and connection process to be executed in step S908 is described later (refer to, for example, FIG. 10).

The communication control device 300 adds, to the connection priority table for the registered terminal selected in step S907, a symbol indicating “connected”, and the communication control device 300 places the information of the registered terminal selected in step S907 at the bottom in the connection priority table (in step S909).

The communication control device 300 determines whether or not a secondary disaster has occurred (in step S910). If the secondary disaster has occurred (Yes in step S910), the communication control device 300 removes the symbol indicating “connected” and added in step S909 (in step S911) and causes the process to proceed to step S912. Thus, if the secondary disaster has occurred, the communication control device 300 may execute the call and connection process on the registered terminal subjected to the call and connection process.

A process of placing information of a registered terminal at the bottom in the connection priority table in step S909 is a process of prioritizing a communication terminal that is not connected upon a primary disaster over a communication terminal to be reconnected upon a secondary disaster and may be another priority determination process. For example, the communication control device 300 may sort the connection information items (registered terminals) of the connection priority table 700 again based on whether or not the call and connection process is already executed, or the like.

If the secondary disaster has not occurred (No in step S910), the communication control device 300 determines whether or not a registered terminal to which the symbol that indicates “connected” is not added exists in the connection priority table (in step S912). If a registered terminal to which the symbol that indicates “connected” is not added exists (Yes in step S912), the communication control device 300 causes the process to return to step S907.

If a registered terminal to which the symbol that indicates “connected” is not added does not exist (No in step S912), the communication control device 300 notifies the target area set in step S901 of the termination of the disaster mode (in step S913) and terminates the process illustrated in FIG. 9.

Call and Connection Process

FIG. 10 is a flowchart of an example of the call and connection process. The communication control device 300 executes steps illustrated in FIG. 10 as the call and connection process that is executed on the interested registered terminal in step S908 illustrated in FIG. 9, for example. First, the communication control device 300 acquires, from the connection destination information acquired in step S903 illustrated in FIG. 9, a “connection method” and an “unattended communication method” that correspond to the interested registered terminal (in step S1001).

The communication control device 300 determines whether or not a bandwidth limit is set (in step S1002). If the bandwidth limit is set (Yes in step S1002), the communication control device 300 determines whether or not the number of currently connected terminals reaches the maximum connection number (in step S1003). If the number of the currently connected terminals does not reaches the maximum connection number (No in step S1003), the communication control device 300 causes the call and connection process to proceed to step S1005.

If the number of the currently connected terminals reaches the maximum connection number (Yes in step S1003), the communication control device 300 waits for release of a connection call (in step S1004). After the connection call is released, the communication control device 300 causes the call and connection process to proceed to step S1005.

The communication control device 300 may set an upper limit on the number of voice calls during connections for each of location registration areas (LAIs) of connection destination terminals of an interested registered terminal, keep connections in excess of the upper limit on hold, and thereby avoid network resources being occupied.

If the bandwidth limit is not set (No in step S1002), the communication control device 300 calls the interested registered terminal (in step S1005). Next, the communication control device 300 determines whether or not the communication control device 300 has received a paging response to the call of step S1005 from the interested registered terminal (in step S1006). If the communication control device 300 has not received the paging response (No in step S1006), the communication control device 300 terminates the call and connection process.

If the communication control device 300 has received the paging response (Yes in step S1006), the communication control device 300 inquires of the interested registered terminal whether or not the registered terminal wants to receive the automatic connection service (in step S1007). For example, the communication control device 300 transmits, to the registered terminal, a message indicating that “the registered terminal wants to be connected to 0A0-aaaa-bbb1 (Mr. or Ms. B) by the automatic connection service? (Yes or No)”. The communication control device 300 receives, from the registered terminal, response information indicating “Yes” or “No”. If a user of the registered terminal stays with a user of a connection destination terminal and does not have to confirm the safety, a wasteful connection service may be avoided by selecting “No”.

Next, the communication control device 300 determines whether or not the communication control device 300 has received a response to the inquiry of step S1007, while the response indicates that the registered terminal wants to receive the automatic connection service and (in step S1008). If the communication control device 300 has not received the response that indicates that the registered terminal wants to receive the automatic connection service (No in step S1008), the communication control device 300 terminates the call and connection process.

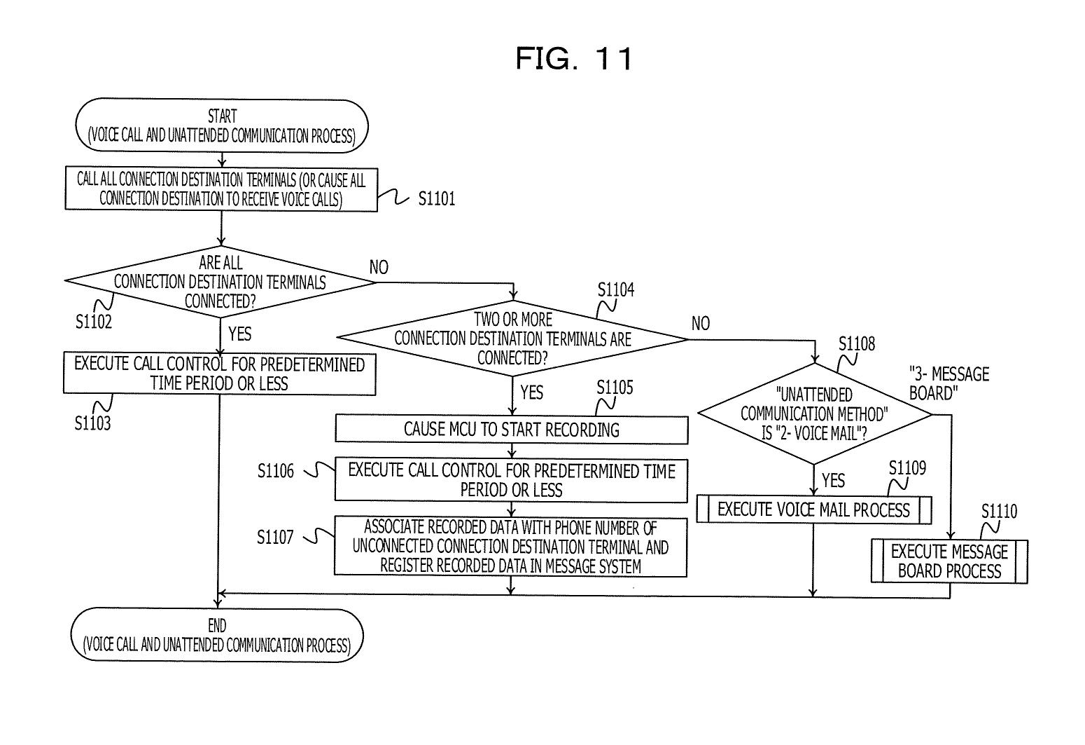

If the communication control device 300 has received the response that indicates that the registered terminal wants to receive the automatic connection service (Yes in step S1008), the communication control device 300 determines whether or not the “connection method” acquired in step S1001 is “1-voice call” (in step S1009). If the “connection method” is “1-voice call” (Yes in step S1009), the communication control device 300 executes a given voice call and unattended communication process (in step S1010) and terminates the call and connection process. The voice call and unattended communication process of step S1010 is described later (refer to, for example, FIG. 11).

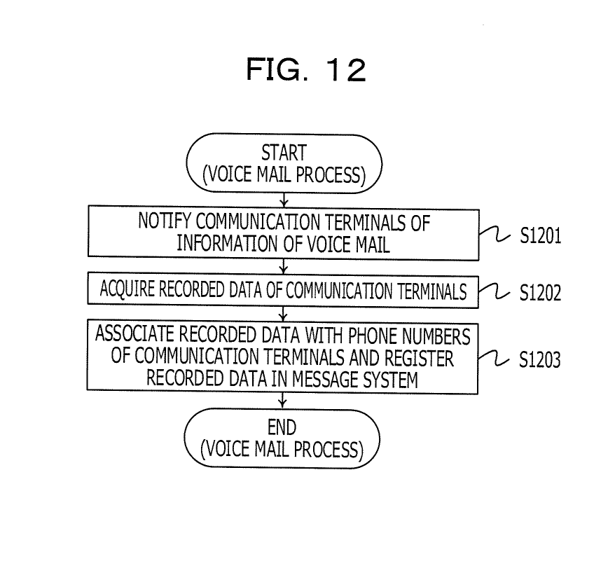

If the “connection method” is not “1-voice call” (No in step S1009), the communication control device 300 determines whether or not the “connection method” acquired in step S1001 is “2-voice mail” (in step S1011). If the “connection method” is “2-voice mail” (Yes in step S1011), the communication control device 300 executes a given voice mail process (in step S1012) and terminates the call and connection process. The voice mail process of step S1012 is described later (refer to, for example, FIG. 12).

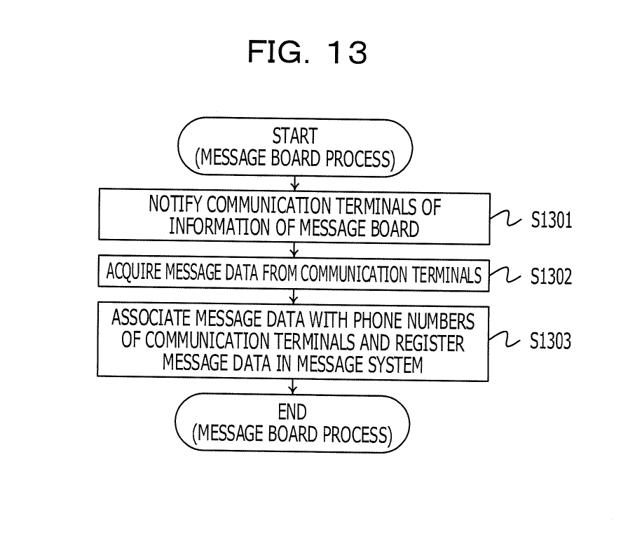

If the “connection method” is not “2-voice mail” (No in step S1011), the communication control device 300 may determine that the “connection method” acquired in step S1001 is “3-message board”. In this case, the communication control device 300 executes a given message board process (in step S1013) and terminates the call and connection process. The message board process of step S1013 is described later (refer to, for example, FIG. 13).

Voice Call and Unattended Communication Process

FIG. 11 is a flowchart of an example of the voice call or unattended communication process. The communication control device 300 executes steps illustrated in FIG. 11 as the voice call and unattended communication process in step S1010 illustrated in FIG. 10, for example. First, the communication control device 300 calls all connection determination terminals of the interested registered terminal (or causes all the connection destination terminals to receive voice calls) (in step S1101).

In step S1101, if the plurality of connection determination terminals of the interested registered terminal exist, the communication control device 300 connects the registered terminal to the connection determination terminals through the MCU 500 by a multipoint connection. The communication control device 300 may transmits, to the connection destination terminals, a message indicating that “an automatic call is placed from 0A0-aaaa-bbbb (Mr. or Ms. A) and a call time is up to N minutes”. The communication control device 300 may transmits, to the registered terminal, a message indicating that “an automatic call will be placed from this terminal and a call time is up to N minutes”.

The communication control device 300 determines whether or not all the connection destination terminals have responded and are connected after a certain time elapses after the calls of step S1101 (in step S1102). If all the connection destination terminals are connected (Yes in step S1102), the communication control device 300 executes call control for a given time period or less (in step S1103) and terminates the voice call and unattended communication process. During the call control of step S1103, calls may be established between the registered terminal and the connection destination terminals.

If at least any of the connection destination terminals is not connected (No in step S1102), the communication control device 300 determines whether or not two or more connection determination terminals are connected (in step S1104). If two or more connection determination terminals are connected (Yes in step S1104), the communication control device 300 causes the voice call and unattended communication process to proceed to step S1105 in order to instantly provide, on a priority basis, the automatic connection service to the connection determination terminals that may communicate with the registered terminal through calls. Specifically, the communication control device 300 causes the MCU 500 to start recording (in step S1105). In this case, the communication control device 300 may transmits, to the communication terminals, a message indicating that “this call will be recorded, recorded data of the call will be transferred to unattended 0A0-aaaa-cccc (Mr. or Ms. C) and a call time is up to N minutes”, for example.

The communication control device 300 executes the call control for a given time period or less (in step S1106). During the call control of step S1106, calls may be established between the registered terminal and the two or more connection destination terminals through the MCU 500 by the multipoint connection and recorded by the MCU 500.

Next, the communication control device 300 associates data recorded by the MCU 500 in step S1106 with a phone number of an unconnected connection destination terminal, registers the recorded data in the message system 1700 (in step S1107), and terminates the voice call and unattended communication process. Thus, when the unconnected connection destination terminal may respond, the recorded data is transferred and a user of the unconnected connection destination terminal may confirm the safety of other users by the transfer of the recorded data. The message system 1700 may be achieved by the IN 261 and the AS 262 that are illustrated in FIG. 2.

If the number of connected connection destination terminals is one or less (No in step S1104), the communication control device 300 determines whether or not the “unattended communication method” acquired in step S1001 illustrated in FIG. 10 is “2-voice mail” (in step S1108). If the “unattended communication method” is “2-voice mail” (Yes in step S1108), the communication control device 300 executes a given voice mail process (in step S1109) and terminates the voice call and unattended communication process. The voice mail process of step S1109 is described later (refer to, for example, FIG. 12).

If the “unattended communication method” is not “2-voice mail” (No in step S1108), the communication control device 300 may determine that the “unattended communication method” is “3-message board”. In this case, the communication control device 300 executes a given message board process (in step S1110) and terminates the voice call and unattended communication process. The message board process of step S1110 is described later (refer to, for example, FIG. 13).

If all the connection destination terminals of the registered terminal do not respond, the communication control device 300 may not add the symbol indicating “connected” to the connection priority table for the interested registered terminal in step S909 and may place the information of the interested registered terminal at the bottom in the connection priority table.

Voice Mail Process

FIG. 12 is a flowchart of an example of the voice mail process. The communication control device 300 executes steps illustrated in FIG. 12 as the voice mail process in step S1012 illustrated in FIG. 10 or step S1109 illustrated in FIG. 11, for example. First, the communication control device 300 notifies the communication terminals that are the registered terminal and the connection destination terminals of information of a voice mail (in step S1201). For example, the communication control device 300 may transmits, to the registered terminal, a message indicating that “your safety information will be transmitted using a recorded voice mail, so please leave a message for 30 seconds after a beep”, for example.

Next, the communication control device 300 acquires recorded data of the communication terminals (in step S1202). The communication control device 300 associates the recorded data of the communication terminals with phone numbers of the communication terminals, registers the recorded data acquired in step S1202 in the message system 1700 (in step S1203), and terminates the voice mail process. Thus, each of the registered terminal and the connection destination terminals may receive the recorded data of the other terminals, and each of the users of the registered terminal and connection destination terminals may confirm the safety of the other users.

Message Board Process

FIG. 13 is a flowchart of an example of the message board process. The communication control device 300 executes steps illustrated in FIG. 13 as the message board process in step S1013 illustrated in FIG. 10 or step S1110 illustrated in FIG. 11, for example. First, the communication control device 300 notifies the communication terminals that are the registered terminal and the connection destination terminals of information of a message board (in step S1301). For example, the communication control device 300 may transmit, to the registered terminal, a message indicating that “your safety information will be registered in a disaster message board, so please enter or select any of the following contents”.

Next, the communication control device 300 acquires message data from the communication terminals (in step S1302). The message data may be text data entered in the communication terminals or may be text data selected from among candidates in the communication terminals. Next, the communication control device 300 associates the message data acquired from the communication terminals in step S1302 with the phone numbers of the communication terminals, registers the message data in the message system 1700 (in step S1303), and terminates the message board process. Thus, each of the registered terminal and the connection destination terminals may receive the message data of the other terminals, and each of the users of the registered terminal and connection destination terminals may confirm the safety of the other users.

Registration Operation in Communication System

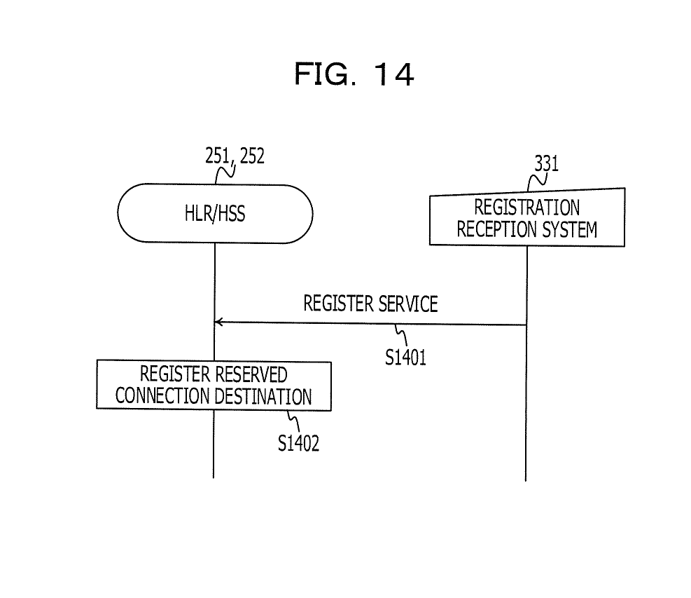

FIG. 14 is a sequence diagram illustrating an example of registration operations in the communication system. For the communication control device 300, steps S1401 and S1402 illustrated in FIG. 14 are executed before a disaster occurs. First, a user who subscribes to the automatic connection service is registered in the subscriber DB 332 installed in the HLR 251 or the HSS 252 through the registration reception system 331 (in step S1401).

In step S1401, the phone number of the registered terminal, the phone numbers of the connection destination terminals to be connected to the registered terminal, an “application priority”, a “connection method”, and a “unattended communication method” are transmitted from the registration reception system 331 to the subscriber DB 332. Next, the subscriber DB 332 installed in the HLR 251 or the HSS 252 registers a reserved connection destination in the connection destination information 600 (refer to FIG. 6) (in step S1402) and terminates the registration operation.

Preparation Operation to be Executed when Communication System Detects Disaster

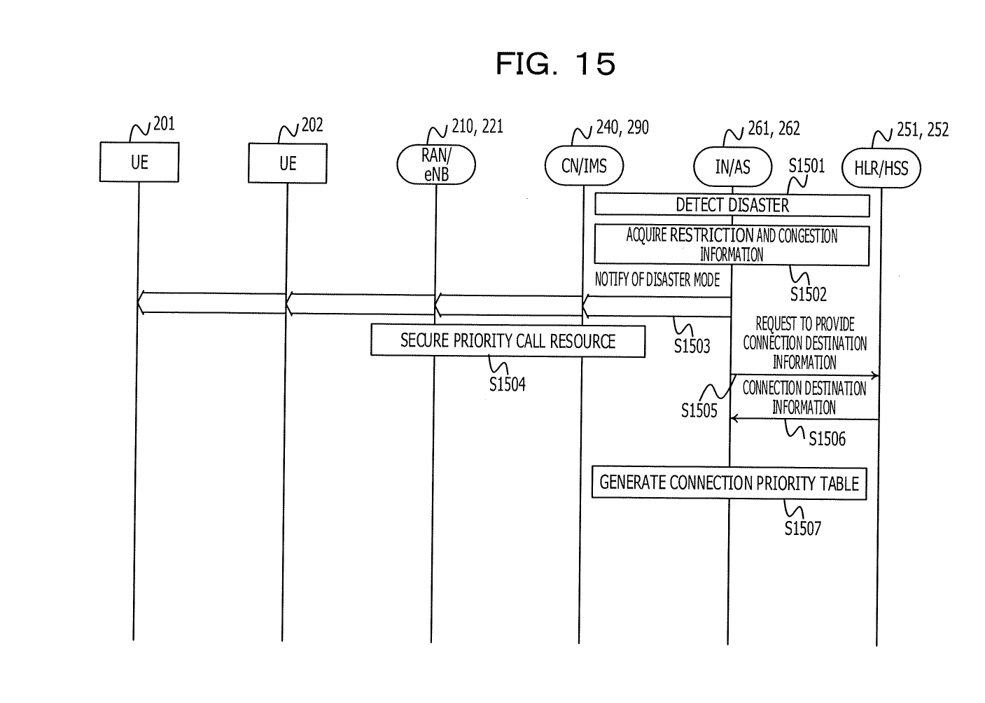

FIG. 15 is a sequence diagram illustrating an example of preparation operations that are executed when the communication system detects a disaster. First, the communication system 200 that includes the IN 261 detects a disaster based on disaster information received from the supervisory ministry or agency 321 or the like (in step S1501). Next, the communication control device 300 installed in the AS 262 acquires the restriction and congestion information from, for example, the IMT network 325 (in step S1502).

Next, the communication control device 300 installed in the AS 262 notifies a target area of the transition to the disaster mode (in step S1503). For example, the core network 240, the IMS 290, the RAN 210, the eNB 221 and the user equipment 201 and 202 are included in the target area notified in step S1503. Next, the core network 240, the IMS 290, the RAN 210, and the eNB 221 secure a priority call resource for the disaster mode due to release of a call placed on hold for a long time period and the bandwidth limit (of, for example, up to 128 kbps) (in step S1504).

Next, the communication control device 300 installed in the AS 262 requests the subscriber DB 332 installed in the HLR 251 or the HSS 252 to provide the connection destination information (in step S1505). Then, the subscriber DB 332 installed in the HLR 251 or the HSS 252 transmits the connection destination information (for example, connection destination information 600) to the communication control device 300 installed in the AS 262 (in step S1506).

The communication control device 300 installed in the AS 262 generates a connection priority table (for example, the connection priority table 700) based on the connection destination information transmitted in step S1506 (in step S1507) and terminates the preparation operation executed upon the detection of the disaster.

Connection Process in Communication System

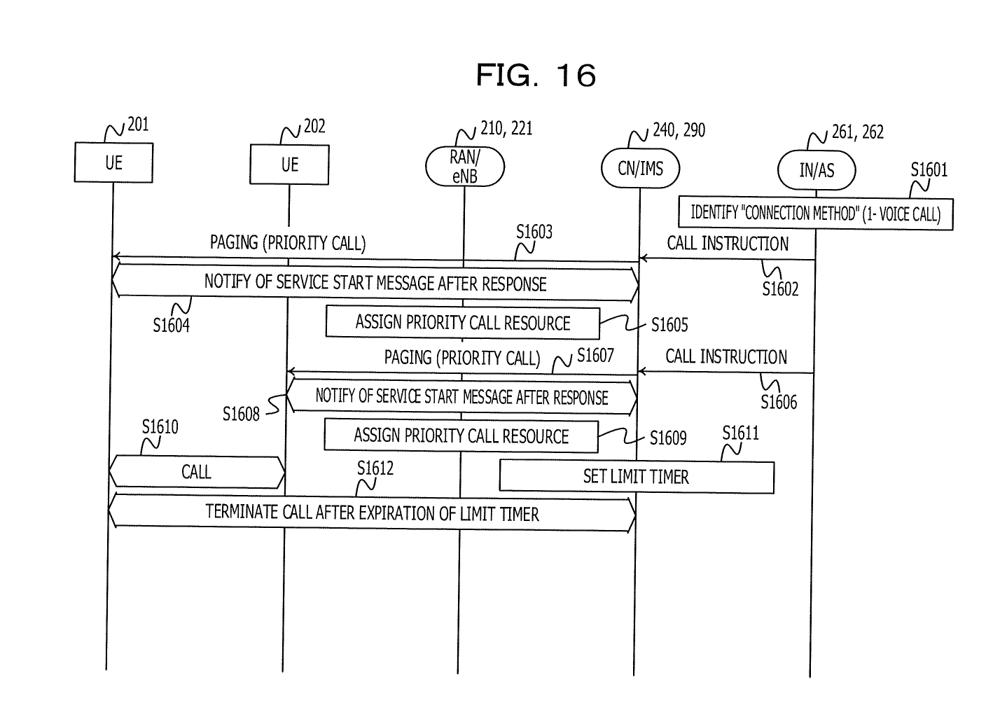

FIG. 16 is a sequence diagram illustrating a first example of a connection process that is executed in the communication system. After the steps S1501 to S1507 illustrated in FIG. 15, steps S1601 to S1612 illustrated in FIG. 16 are executed in the communication system 200. The first example illustrated in FIG. 16 assumes that the connection priority table generated in step S1507 illustrated in FIG. 15 indicates that a registered terminal to be first connected is the user equipment 201 and that a connection destination equipment of the user equipment 201 is the user equipment 202.

First, the communication control device 300 installed in the AS 262 identifies a “connection method” of the user equipment 201 based on the connection destination information acquired in step S1506 illustrated in FIG. 15 (in step S1601). The first example illustrated in FIG. 16 assumes that “1-voice call” is identified as the “connection method” of the user equipment 201 in step S1601.

Next, the communication control device 300 installed in the AS 262 transmits an instruction to call the user equipment 201 to the core network 240 or the IMS 290 (in step S1602). Then, the core network 240 or the IMS 290 executes paging on a priority call to be placed to the user equipment 201 (in step S1603).

For example, if the call instruction is transmitted to the core network 240 in step S1602, the paging is executed through the RAN 210 in step S1603. If the call instruction is transmitted to the IMS 290 in step S1602, the paging is executed through the eNB 221 in step S1603.

Next, the core network 240 or the IMS 290 notifies the user equipment 201 of a service start message after a response from the user equipment 201 (in step S1604). Then, the RAN 210 or the eNB 221 assigns a priority call resource for a voice call of the user equipment 201 (in step S1605).

Then, the communication control device 300 installed in the AS 262 transmits an instruction to call the user equipment 202 to the core network 240 or the IMS 290 (in step S1606). The core network 240 or the IMS 290 executes paging on a priority call to be placed to the user equipment 202 (in step S1607).

For example, if the call instruction is transmitted to the core network 240 in step S1606, the paging is executed through the RAN 210 in step S1607. If the call instruction is transmitted to the IMS 290 in step S1606, the paging is executed through the eNB 221 in step S1607.

The core network 240 or the IMS 290 notifies the user equipment 202 of a service start message after a response from the user equipment 202 (in step S1608). The RAN 210 or the eNB 221 assigns a priority call resource for a voice call of the user equipment 202 (in step S1609).

Thus, a call starts to be established between the user equipment 201 and the user equipment 202 (in step S1610). The core network 240 or the IMS 290 sets a limit timer for counting a given time from the start time of the call established in step S1610 (in step S1611).

After the limit timer set in step S1611 expires, the core network 240 or the IMS 290 forcibly terminates the call between the user equipment 201 and the user equipment 202 (in step S1612) and the connection process executed on the user equipment 201 is terminated. After that, in the same manner, the connection process is executed on each of registered terminals based on the connection priority table generated in step S1507 illustrated in FIG. 15.

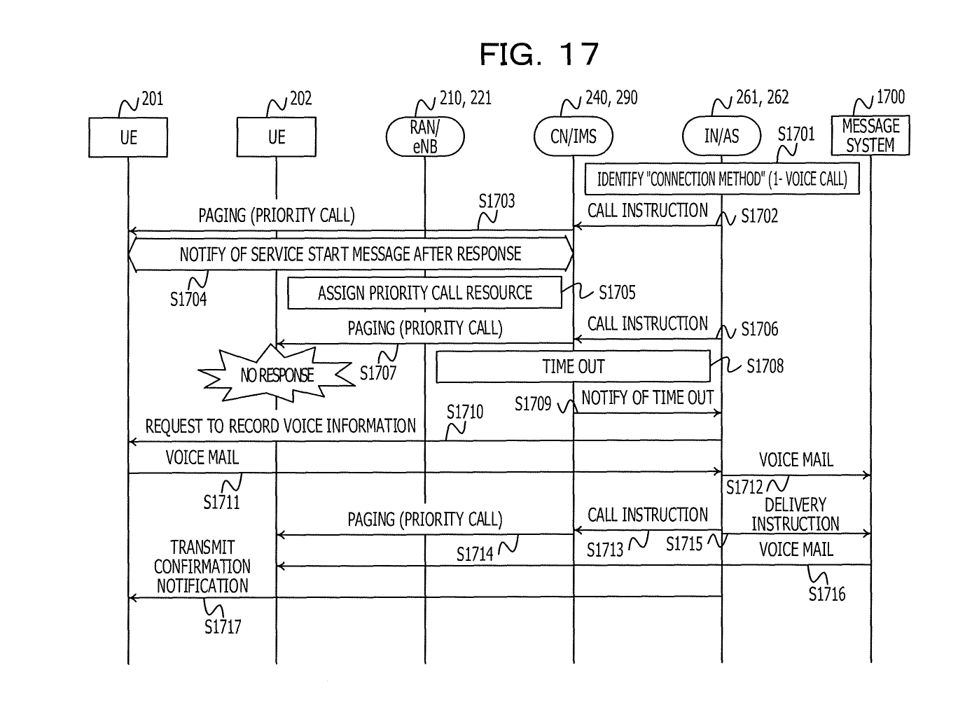

FIG. 17 is a sequence diagram illustrating a second example of the connection process that is executed in the communication system. After steps S1501 to S1507 illustrated in FIG. 15, steps S1701 to S1717 may be executed in the communication system 200. The message system 1700 illustrated in FIG. 17 may be installed in the IN 261 or the AS 262.

The second example illustrated in FIG. 17 assumes that the connection priority table generated in step S1507 illustrated in FIG. 15 indicates that a registered terminal to be first connected is the user equipment 201 and that a connection destination terminal of the user equipment 201 is the user equipment 202. In addition, it is assumed that an “unattended connection method” of the user equipment 201 is “2-voice mail”.

Steps S1701 to S1707 illustrated in FIG. 17 are the same as steps S1601 to S1607 illustrated in FIG. 16. The second example illustrated in FIG. 17 assumes that the user equipment 202 does not respond to the paging executed on the user equipment 202 in step S1707 and that a time out occurs in the core network 240 or the IMS 290 (in step S1708).

In this case, the core network 240 or the IMS 290 notifies the communication control device 300 installed in the AS 262 of the time out (in step S1709). Then, the communication control device 300 installed in the AS 262 requests the user equipment 201 to record voice information and transmit a voice mail (in step S1710).

The user equipment 201 records voice information of the user and transmits a voice mail generated based on the recorded voice information to the communication control device 300 installed in the AS 262 (in step S1711). The communication control device 300 installed in the AS 262 associates the voice mail transmitted in step S1711 with the phone number of the user equipment 201 and registers the voice mail in the message system 1700 (in step S1712).

The communication control device 300 installed in the AS 262 transmits an instruction to call the user equipment 202 to the core network 240 or the IMS 290 after confirming that the user equipment 202 is located in a service area (in step S1713). The core network 240 or the IMS 290 executes the paging on a priority call to be placed to the user equipment 202 (in step S1714).

If the call instruction is transmitted to the core network 240 in step S1713, the paging is executed through the RAN 210 in step S1714. If the call instruction is transmitted to the IMS 290 in step S1713, the paging is executed through the eNB 221 in step S1714.

Next, the communication control device 300 installed in the AS 262 transmits, to the message system 1700, an instruction to deliver the voice mail to the user equipment 202 (in step S1715). The message system 1700 associates the voice mail registered in the message system 1700 with the phone number of the user equipment 202 and transmits the voice mail to the user equipment 202 (in step S1716).

The communication control device 300 installed in the AS 262 transmits, to the user equipment 201, a confirmation notification indicating that the voice mail has been delivered to the user equipment 202 (in step S1717), and the communication control device 300 terminates the connection process. After that, in the same manner, the connection process is executed on each of the other registered terminals based on the connection priority table generated in step S1507 illustrated in FIG. 15.

Although FIG. 17 illustrates the case where the “unattended communication method” of the user equipment 201 is “2-voice mail”, the “unattended communication method” of the user equipment 201 may be “3-message board”. In this case, the communication control device 300 installed in the AS 262 requests the user equipment 201 to transmit message data (text data) in step S1710, for example.

In step S1711, the user equipment 201 transmits the message data entered or selected by the user to the communication control device 300 installed in the AS 262. In step S1712, the communication control device 300 installed in the AS 262 associates the message data transmitted in step S1711 with the phone number of the user equipment 201 and registers the message data in the message system 1700.

In step S1715, the communication control device 300 installed in the AS 262 transmits, to the message system 1700, an instruction to deliver the message data to the user equipment 202. In step S1716, the message system 1700 associates the message data registered in the message system 1700 with the phone number of the user equipment 202 and transmits the message data to the user equipment 202.

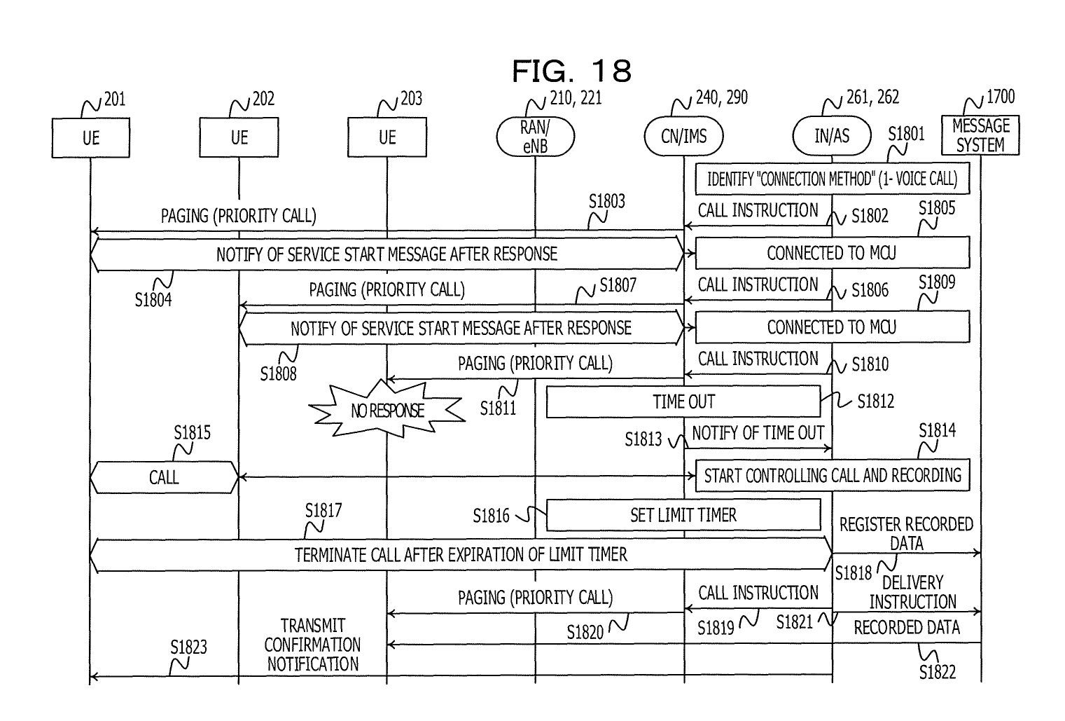

FIG. 18 is a sequence diagram illustrating a third example of the connection process that is executed in the communication system. After the steps S1501 to S1507 illustrated in FIG. 15, steps S1801 to S1823 illustrated in FIG. 18 may be executed in the communication system 200. The third example illustrated in FIG. 18 assumes that the connection priority table generated in step S1507 illustrated in FIG. 15 indicates that a registered terminal to be first connected is the user equipment 201 and that connection destination terminals of the user equipment 201 are the user equipment 202 and 203.

Steps S1801 to S1804 are the same as steps S1601 to S1604 illustrated in FIG. 16. After step S1804, the communication control device 300 installed in the AS 262 connects the user equipment 201 to the MCU 500 (in step S1805). Steps S1806 to S1808 are the same as steps S1606 to S1608 illustrated in FIG. 16. After step S1808, the communication control device 300 installed in the AS 262 connects the user equipment 202 to the MCU 500 (in step S1809).

Then, the communication control device 300 installed in the AS 262 transmits, to the core network 240 or the IMS 290, an instruction to call the user equipment 203 (in step S1810). The core network 240 or the IMS 290 executes paging on a priority call to be placed to the user equipment 203 (in step S1811).

For example, if the call instruction is transmitted to the core network 240 in step S1810, the paging is executed through the RAN 210 in step S1811. If the call instruction is transmitted to the IMS 290 in step S1810, the paging is executed through the eNB 221 in step S1811.

It is assumed that the user terminal 203 does not respond to the paging executed on the user equipment 203 in step S1811 and that a time out occurs in the core network 240 or the IMS 290 (in step S1812). In this case, the core network 240 or the IMS 290 notifies the communication control device 300 installed in the AS 262 of the time out (in step S1813).

The communication control device 300 installed in the AS 262 causes the MCU 500 installed in the IN 261 to start controlling a call between the user equipment 201 and the user equipment 202 and recording the call between the user equipment 201 and the user equipment 202 (in step S1814).

Thus, the call starts to be established between the user equipment 201 and the user equipment 202 (in step S1815). In addition, the core network 240 or the IMS 290 sets a limit timer for counting a given time from the start time of the call established in step S1815 (in step S1816).

After the limit timer set in step S1816 expires, the core network 240 or the IMS 290 forcibly terminates the call between the user equipment 201 and the user equipment 202 (in step S1817). The MCU 500 installed in the IN 261 associates data obtained by recording the call between the user equipment 201 and the user equipment 202 in step S1814 with a phone number of the user equipment 203 and registers the recorded data in the message system 1700 (in step S1818).

After confirming that the user equipment 203 is located in a service area, the communication control device 300 installed in the AS 262 transmits, to the core network 240 or the IMS 290, an instruction to call the user equipment 203 (in step S1819). The core network 240 or the IMS 290 executes paging on a priority call to be placed to the user equipment 203 (in step S1820).

For example, if the call instruction is transmitted to the core network 240 in step S1819, the paging is executed through the RAN 210 in step S1820. If the call instruction is transmitted to the IMS 290 in step S1819, the paging is executed through the eNB 221 in step S1820.

The communication control device 300 installed in the AS 262 transmits, to the message system 1700, an instruction to deliver the recorded data to the user equipment 203 (in step S1821). The message system 1700 associates the recorded data registered in the message system 1700 with the phone number of the user equipment 203 and transmits the recorded data to the user equipment 203 (in step S1822).

The communication control device 300 installed in the AS 262 transmits, to the user equipment 201, a confirmation notification indicating that the recorded data has been delivered to the user equipment 203 (in step S1823). Then, the communication control device 300 installed in the AS 262 terminates the connection process. After that, in the same manner, the connection process is executed on the other registered terminals based on the connection priority table generated in step S1507 illustrated in FIG. 15.

As described above, the communication control device, the communication control method, and the communication system may enable the safety of a user to be efficiently confirmed.

If a disaster occurs in a large region, phones may not be connected for a long time due to congestion of mobile phones and landline phones even in a region that is not directly affected by the disaster, and many people may spend time while being worried about the safety of their families and acquaintances. The communication control device 110, however, may control traffic at the initiative of the network side and thereby provide a scheme (voice call connection or the like) for reliably confirming safety for a short time.

An example of measures for congestion of a network upon the occurrence of a disaster is an access control to restrict an access for a call. A user, however, may repeatedly place a wasteful call operation because the user is not able to recognize the execution of the access control or the user tries to quickly contact another user and confirm the safety of the other user. Thus, the network may be congested and it may be difficult to confirm the safety. The communication control device 110, however, registers, for each of users, contact information of a person of which the safety is to be confirmed by the user upon the occurrence of a disaster, and the communication control device 110 may sequentially connect a terminal used by the user to a terminal used by the person corresponding to the contact information at the initiative of the network side. It may therefore be possible to suppress a rapid increase in the number of requests for communication upon the occurrence of a disaster and efficiently confirm safety.

Traditionally, as measures for congestion of a network upon the occurrence of a disaster or a scheme for confirming safety, a message system for disasters is activated. For functions of conventional message systems, a message system to be used is determined in advance by users who want to contact each other upon the occurrence of a disaster. On the other hand, when the message system 1700 is used for a voice mail, message data, or the like, the communication control device 110 may transfer the voice mail registered in the message system 1700, the message data registered in the message system 1700, or the like to a communication terminal at the initiative of the network side. Thus, the safety may be easily confirmed even if a message system to be used is not determined in advance by users who want to contact each other upon the occurrence of a disaster.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication control device comprising:
a memory; and
a processor coupled to the memory and configured to:
acquire association information in which identification information of a first communication terminal is associated with identification information of a second communication terminal that is different from the first communication terminal,
detect occurrence of a disaster, and
execute call control so as to call the first communication terminal and the second communication terminal and enable a call to be established between the first communication terminal and the second communication terminal based on the acquired association information when the processor detects the occurrence of the disaster.

2. The communication control device according to claim 1,
wherein in the association information, each of a plurality of the first communication terminals is associated with the second communication terminal that is different from the plurality of first communication terminals, and
wherein the processor is configured to sequentially execute the call control on the plurality of first communication terminals.

3. The communication control device according to claim 2,
wherein the processor is configured to set limits on call times of the plurality of first communication terminals.

4. The communication control device according to claim 2,
wherein the processor is configured to execute the call control on the plurality of first communication terminals in the order based on a locational relationship between a location at which the disaster has occurred and the location of at least any of the first and second communication terminals.

5. The communication control device according to claim 2,
wherein the processor is configured to execute the call control on the plurality of first communication terminals in the order based on the status of an access control provided for an area in which at least any of the first and second communication terminals is located.

6. The communication control device according to claim 2,
wherein the processor is configured to execute the call control on the plurality of first communication terminals in the order based on the state of congestion in an area in which at least any of the first and second communication terminals is located.

7. The communication control device according to claim 1,
wherein the processor is configured to call the first communication terminal and receives a voice message from the first communication terminal when the occurrence of the disaster is detected, and
wherein the processor is configured to call the second communication terminal and transfers the voice message to the second communication terminal.

8. The communication control device according to claim 1,
wherein the processor is configured to call the second communication terminal and receives a voice message from the second communication terminal when the occurrence of the disaster is detected, and
wherein the processor is configured to call the first communication terminal and transfers the voice message to the first communication terminal.

9. The communication control device according to claim 1,
wherein the processor is configured to call the first communication terminal and receives a text message from the first communication terminal when the occurrence of the disaster is detected, and
wherein the processor is configured to call the second communication terminal and transfers the text message to the second communication terminal.

10. The communication control device according to claim 1,
wherein the processor is configured to call the second communication terminal and receives a text message from the second communication terminal when the occurrence of the disaster is detected, and
wherein the processor is configured to call the first communication terminal and transfers the text message to the first communication terminal.

11. The communication control device according to claim 1,
wherein when the first communication terminal is associated with a plurality of the second communication terminals in the association information, the controller calls the first communication and the plurality of second communication terminals and enables a call to be established between a plurality of communication terminals that are among the first and second communication terminals and have responded to the calls, and
wherein the processor is configured to call a communication terminal different from the plurality of communication terminals among the first and second communication terminals and transfers recorded data of the call established between the plurality of communication terminals to the different communication terminal.

12. A communication control method comprising:
acquiring association information in which identification information of a first communication terminal is associated with identification information of a second communication terminal that is different from the first communication terminal; and
executing, by a processor, call control so as to call the first communication terminal and the second communication terminal and enable a call to be established between the first communication terminal and the second communication terminal based on the acquired association information when occurrence of a disaster is detected.

13. A communication system comprising:
a first communication terminal configure to execute radio communication;
a second communication terminal different from the first communication terminal, configured to execute radio communication; and
a communication control device configured to:
acquire association information in which identification information of the first communication terminal is associated with identification information of the second communication terminal, and
execute call control so as to call the first communication terminal and the second communication terminal and enable a call to be established between the first communication terminal and the second communication terminal based on the acquired association information when occurrence of a disaster is detected.
